(19) United States
(12) Patent Application Publication
(10) Pub. No.: US 2021/0195865 A1
(43) Pub. Date: Jul. 1, 2021

(54) Pet cooling Pad

(71) Applicant: Yong WANG, Shanghai (CN)

(72) Inventor: Yong WANG, Shanghai (CN)

(21) Appl. No.: 16/732,062

(22) Filed: Dec. 31, 2019

(51) Int. Cl. A01K 1/015; A47G 9/02; B32B 3/04; B32B 5/02; B32B 5/18; B32B 5/24; B32B 9/04; C09K 5/08

(52) U.S. Cl. CPC A01K 1/0157; A47G 9/0215; B32B 3/04; B32B 5/02; A47G 2009/008; B32B 5/245; B32B 9/046; B32B 9/047; C09K 5/08; B32B 5/18

(57) ABSTRACT

Present invention teaches construction of a pet cooling pad by mixing four substances into a gel layer. A soft fabric layer then wraps the gel layer together with a light sponge layer into an integrated pad. An anti-slip layer can be added to the bottom to provide more stable grip to the surface the pad is place upon, especially when the pad is used in a moving vehicle to transport pets. Optionally, the soft fabric layer can be made to be waterproof, easy for a pet owner to take care of and/or clean the pad products.

### FIELD AND BACKGROUND OF THE INVENTION

Present invention disclosed herein relates to the field of providing cool and comfortable resting pad for pets. Portable and cushion-like pads have been available in the market that enables domestic pets, such as dogs or cats, to sit, sleep or otherwise rest upon. The typical use of such pads is mostly inside a house.

However, not many pads provide the cushy comfort along with a cooling effect especially when the temperature is high, whether in outdoors or indoors setting. Pets tend to get restless when their place of resting is not comfortable.

Additionally, pets are sometimes brought along by their owners on trips while sitting or staying in open space, such as the back of a pickup truck with a pet crate, a pet bed or some containment gadgets of suitable size to accommodate the pets. In a hot weather, putting a cooling pad of present invention inside a crate, or other gadgets, helps to make it more comfortable for the pet(s) being transported.

Present invention provides an innovated pad that has good cooling effect and will help to keep pets to stay comfortable and calm, a feature not quite available on the market.

### SUMMARY OF THE INVENTION

The cooling pad of present invention primarily consists of a gel layer and a light sponge layer, with soft surface fabrics wrapping up the two layers on the outside, forming an integrated pad.

The gel layer is made up by mixing the four substances of glycerin, menthol, de-ionized water and tartaric acid in substantially the ratio of 35%:0.8%:55%:9.2% by weight, and by putting them in an industrial mixer for ten minutes, operating at room temperature of between 18 and 28 degrees Celsius.

The light sponge layer can be made from any soft cushy material suitable generally available on the market place.

Additionally, an anti-slip layer can be added to the bottom of the pad, integrated with the fabric layer wraps over the gel layer and the light sponge layer, to increase the gripping power of the pad to a floor surface upon which the pad product is placed.

The anti-slip layer is most helpful in the case where a pad is place in a moving vehicle, such as the back of a truck or van. This layer adds to the stability and steadiness of the pad, while providing cooling comfort to the pets resting or sitting on the pad.

Despite the gel layer and the light sponge layer being wrapped inside a fabric layer, there may have some relative movement between these two layers. A thin layer of glue can be applied to bond the gel layer and the light sponge layer together, eliminating the movements between the two layers.

In addition to using glue, any commercially available bonding material can be used to bond the gel layer and the light sponge layer together.

The gel layer can be made into other configurations of padding material based upon the four substances and the mixing instructions made herein.

For example, the gel layer can be made into an end product by itself, without the sponge layer, with an outside fabric layer wrapping over the gel layer. As such, a gel cool layer product can be used not just for a pet to sit or rest on it, it can be used to drape over a pet as well to provide cooling effect.

Optionally, the soft fabric layer can be made to be waterproof, making it easy to pet owners to take care and clean the pad products.

### DESCRIPTION OF THE DRAWINGS

The accompanying drawings exemplify the preferred embodiments of the invention. Together with the description, serve to explain the principles of the invention.

A brief description of the drawings is as follows:

FIG. 1 show a pad with the gel layer and the light sponge layer, wrapped inside a soft fabric layer.

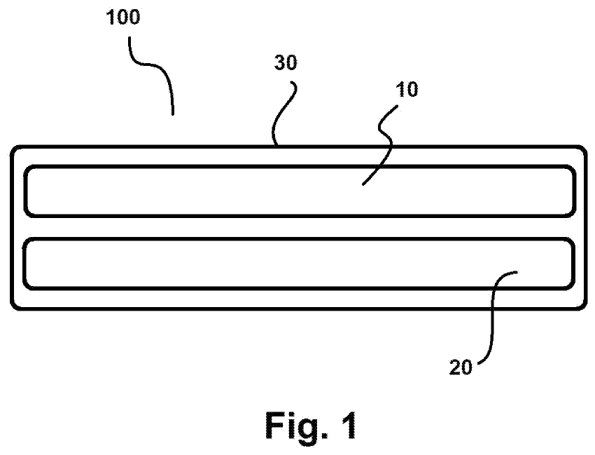

FIG. 2 shows a layer of glue between the gel layer and the light sponge layer, with an anti-slip layer at the bottom.

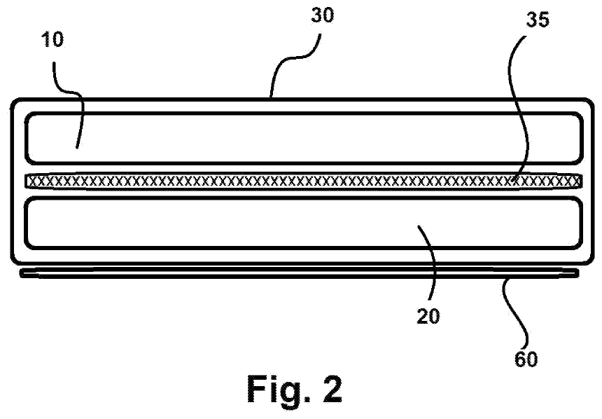

FIG. 3 shows a gel layer compound with soft fabric layer wrapping on the outside.

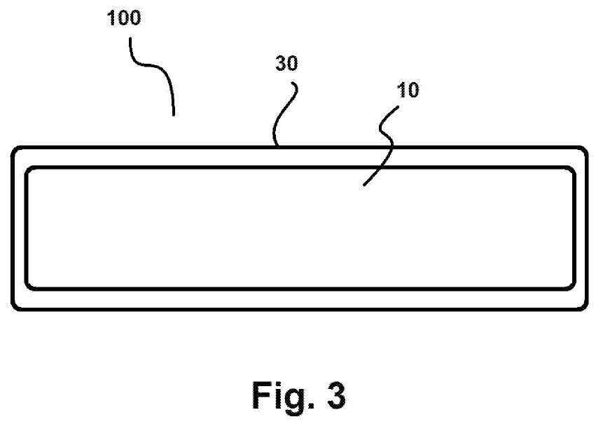

### DETAILED DESCRIPTION OF THE PREFERRED EMBODIMENT

The cooling pad 100 of present invention primarily consists of a gel layer 10 and a light sponge layer 20, with a soft fabric layer 30 wrapping up the two layers on the outside, forming an integrated pad.

The gel layer 10 is made up by mixing the four substances of glycerin, menthol, de-ionized water and tartaric acid in substantially the ratio of 35%:0.8%:55%:9.2% by weight, and by putting them in an industrial mixer for ten minutes, operating at room temperature of between 18 and 28 degrees Celsius.

The soft fabric layer 30 can be made from various household or commercially available fabrics. Additionally, the soft fabric layer 30 can be made to be water resistant by using waterproof material(s) including but not limited to common plastic, or polyester fabrics. Additionally, the soft fabric layer 30 can also contain a water-resistant coating, rending it to be substantially waterproof.

The light sponge layer 20 can be made from any soft cushy material suitable generally available on the market place.

Additionally, an anti-slip layer 60 can be added to the bottom, integrated with the fabric layer 30, to increase the gripping power of the pad to a floor surface upon which the pad product is placed.

Despite the gel layer 10 and the light sponge layer 20 being wrapped inside a fabric layer 30, there may have some relative movement between these two layers. A thin layer of glue 15 can be applied to glue the gel layer 10 and the light sponge layer 20 together, eliminating the movements between the two layers. There is no limitation as to what type of bonding agent or material can be used for the glue layer 15. In addition to using glue, any suitable industrial and/or chemical bonding agent material can be used to bond the gel layer 10 and the light sponge layer 20 together when wrapped inside the soft fabric layer 30.

The anti-slip layer 60 is most helpful where the pad of present invention is used in a moving vehicle, such as the back of a truck or van. This anti-slip layer 60 adds to the stability and steadiness of the pad 100, while providing cooling comfort to the pets resting or sitting on the pad.

The gel layer 10 can be made into other configurations of padding material based upon the four substances and the mixing instructions made herein, all are within the scope of present invention's disclosure.

For example, the gel layer 10 can be made into an end product by itself, without the light sponge layer 20, with proper surface wrapping such as the fabric layer 30. As such, a gel cool layer product can be used not just for a pet to sit or rest on it, it can be used to drape over a pet as well to provide cooling effect.

The soft fabric layer 30 in this embodiment similarly can be made to be waterproof or water resistant by the materials used or coating as discussed herein.

The materials for the soft fabric layer 30 and the light sponge layer 20 require no separate teaching in this application as a person of ordinary skill in the art would be able to practice the invention by using commonly available materials to build or make the products as disclosed herein.

The applied-for invention is not limited by the specific embodiments enumerated herein. All additional embodiments are within the scope of the disclosure as long as they fit within the spirits and teachings of present application.

1. A cooling pad, comprising:
a gel layer with the gel made up by mixing the four substances glycerin, menthol, de-ionized water and tartaric acid in substantially the ratio of 35%:0.8%:55%:9.2% by weight;
a light sponge layer; and
a soft fabric layer wraps over the gel layer and the light sponge layer to form an integrated pad, wherein
the gel layer is made by mixing the four substances in an industrial mixer for ten minutes, operating at room temperature of between 18 and 28 degrees Celsius.

2. The cooling pad of claim 1, wherein an anti-slip layer is added to the bottom of the integrated pad to increase the gripping power of the pad to a floor surface upon which the pad product is placed.

3. The cooling pad of claim 1, wherein the light sponge layer can be any soft cushy material suitable generally available on the market place.

4. The cooling pad of claim 1, wherein the soft fabric layer is made to be waterproof.

5. The cooling pad of claim 1, wherein a thin layer of glue is used to bond the gel layer and the light sponge layer together.

6. The cooling pad of claim 5, wherein any commercial bonding material can be used as the glue to bond the gel layer and the light sponge layer together.

7. A cooling gel compound layer, comprising gel compound made from four substances of glycerin, menthol, de-ionized water and tartaric acid in substantially the ratio of 35%:0.8%:55%:9.2% by weight wherein the gel compound is formed by mixing the four substances in an industrial mixer for ten minutes, operating at room temperature of between 18 and 28 degrees Celsius.

8. A cooling gel compound layer of claim 7, further comprising a soft fabric layer wrapping over the exterior surface of the gel compound.

9. The cooling gel compound layer of claim 8, wherein the soft fabric layer is made to be waterproof.
